(19) United States
(12) Patent Application Publication
(10) Pub. No.: US 2003/0205603 A1
(43) Pub. Date: Nov. 6, 2003

(54) Tape-roll fitting device of an adhesive tape holder

(76) Inventor: Hsiu-Man Yu Chen, Taichung (TW)

Correspondence Address: TROXELL LAW OFFICE PLLC, SUITE 1404, 5205 LEESBURG PIKE, FALLS CHURCH, VA, 22041, US

(21) Appl. No.: 10/136,336

(22) Filed: May 2, 2002

(51) Int. Cl. B32B 31/00

(52) U.S. Cl. 225/56; 225/77

(57) ABSTRACT

A tape-roll fitting device of an adhesive tape holder includes a cutting device, a small rotating wheel and a large rotating wheel. A projecting clasp is provided on a groove wall of a receiving space in the front portion of the small rotating wheel, having a cut groove respectively at opposite lengthwise sides. The hook of the clasp extends out of the outer edge of the small rotating wheel and forms a press member. The large rotating wheel is bored with three recessed grooves around the outer circumference at its front end for the clasp of the small rotating wheel to be fixedly secured therein. Then the tape-roll fitting device is easy in handling and convenient in assembling or disassembling.

### BACKGROUND OF THE INVENTION

This invention relates to tape-roll fitting device of an adhesive tape holder, particularly to one capable of alternatively fitting a large or a small adhesive tape roll, easy in handling, and convenient in assembling and disassembling.

A conventional tape-roll fitting device of an adhesive tape holder, as disclosed in the U.S. Pat. No. 5,110,401, has a carrier rotatably mounted on a shaft by means of a positioner, a stopper and a spring. The spring elastically pushes against the carrier to regulate the rotating force of the carrier, and two metal pieces have their projections respectively engaged in shaft holes to protect the carrier from wearing away in rotating.

However, the foresaid conventional device only functions to regulate the rotating force of the carrier. In case of assembling or disassembling the carrier, the positioner, the stopper and the spring must first be removed from the carrier, complicated in process.

### SUMMARY OF THE INVENTION

The objective of the invention is to offer a tape-roll fitting device of an adhesive tape holder, easy in handling and convenient in assembling and disassembling.

The tape-roll fitting device of an adhesive tape holder includes a cutting device, a small rotating wheel and a large rotating wheel. The small rotating wheel has an outward projecting clasp provided at a preset location on a grooved wall of a receiving space in its front portion. The clasp has a cut groove preset in length formed at opposite lengthwise sides, and the hook of the clasp extends out of the outer edge of the small rotating wheel and forms a projecting press member. The large rotating wheel is provided with recessed grooves preset in number around the outer circumference at its front end for the clasp of the small rotating wheel to be fixedly secured therein. Then the tape-roll fitting device can be easily assembled and disassembled so as to place a large tape roll on the large rotating wheel or a small tape roll on the small rotating wheel easily and quickly.

### BRIEF DESCRIPTION OF DRAWINGS

This invention will be better understood by referring to the accompanying drawings, wherein:

FIG. 1 is a perspective view of an adhesive tape holder with a tape-roll fitting device in the present invention:

FIG. 2 is an exploded perspective view of the tape-roll fitting device of an adhesive tape holder in the present invention:

FIG. 3 is a perspective view of a small rotating wheel of the tape-roll fitting device in the present invention:

FIG. 4 is a cross-sectional view of a large rotating wheel assembled on the small rotating wheel in the present invention.

### DETAILED DESCRIPTION OF THE PREFERRED EMBODIMENT

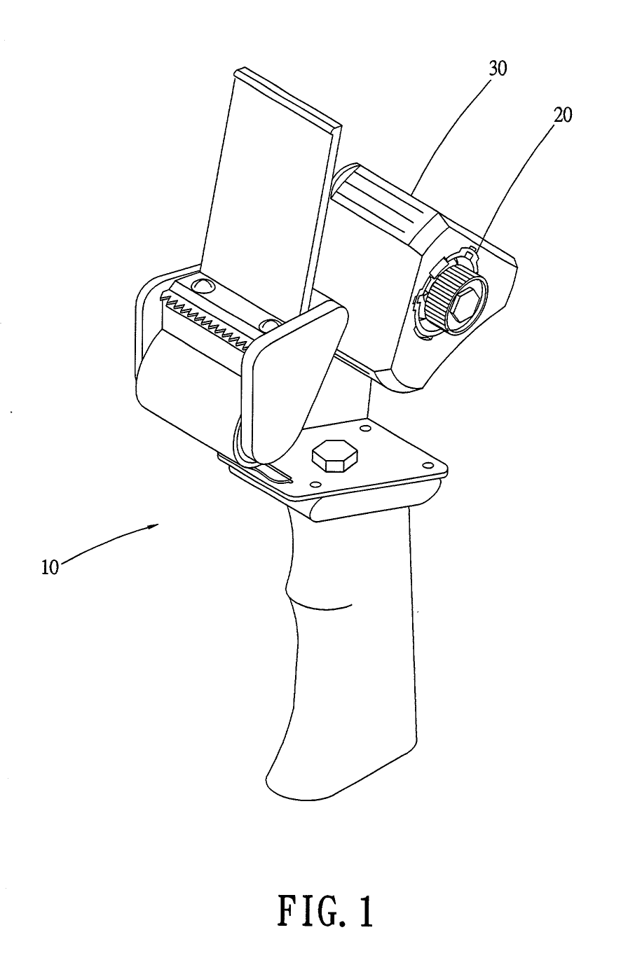

A preferred embodiment of a tape-roll fitting device of an adhesive tape holder in the present invention, as shown in FIG. 1, includes a cutting device 10, a small rotating wheel 20 and a large rotating wheel 30 as main components combined together.

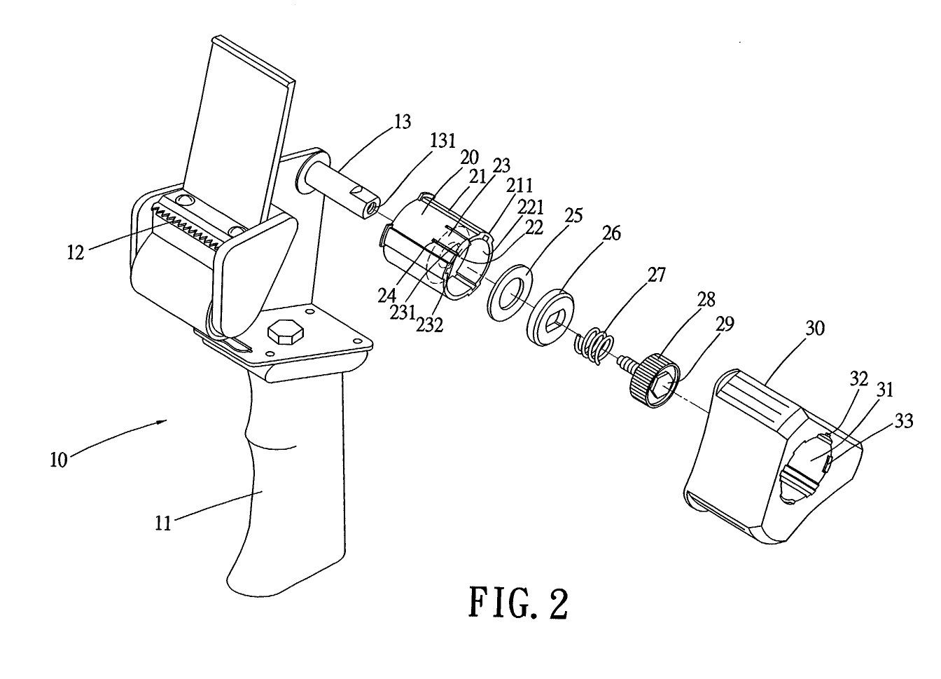

The cutting device 10, as shown in FIG. 2, consists of a handle 11, a saw-toothed blade 12 for cutting off an adhesive tape, and a fixing shaft 13 laterally positioned in the cutting device 10 and having a threaded hole 131 in the center.

The small rotating wheel 20 is fitted around the fixing shaft 13 and axially provided around with projecting and parallel grooved rails 21 preset in number around its outer circumference for a small adhesive tape roll to be positioned thereon

The large rotating wheel 30 has a through shaft hole 31 bored in the center, and a plurality of parallel slide grooves 32 formed around its inner wall to match with the grooved rails 21 of the small rotating wheel 20 so as to let the large and the small rotating wheels axially fitted together and rotated synchronously.

The improved feature of the invention is that the small rotating wheel 20 is provided in the front portion with a receiving space 22 defined with an inner wall 221 and an outward projecting clasp 23 formed to extend out of the inner wall 221. The clasp 23 has a cut groove 24 respectively formed at opposite lengthwise sides and a hook 231 extending out of the outer edge of the small rotating wheel 20 and making up a projecting press member 232 for a user to press.

The large rotating wheel 30 has three recessed grooves 33 bored around the outer circumference of its front end for the clasps 23 of the small rotating wheel 20 to be secured therein.

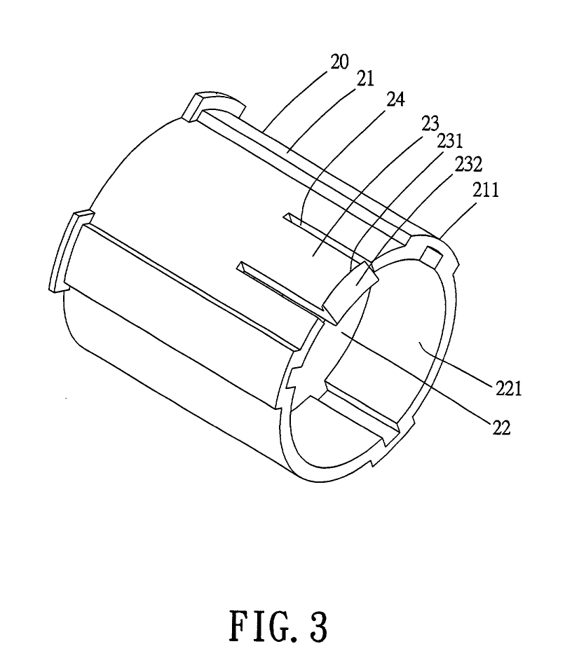

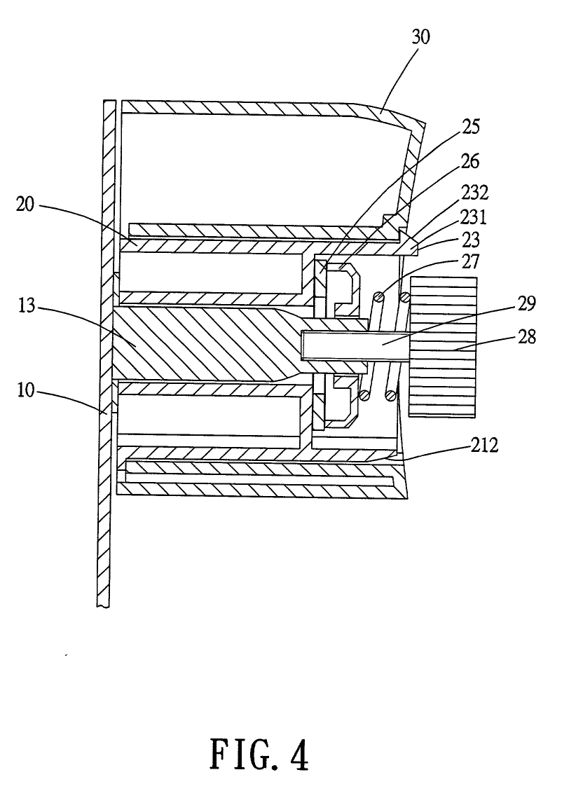

In addition, the outer surface of each grooved rail 21 of the small rotating wheel 20 is formed into a convex surface 211 with its front end portion formed with an outward conical surface 212, as shown in FIGS. 3 and 4.

In assembling, as shown in FIGS. 2 and 4, the small rotating wheel 20 is first fitted around the fixing shaft 13 of the cutting device 10. Next, a gasket 25, a fixing member 26 and a spring 27 are orderly positioned in the receiving groove 22 of the small rotating wheel 20 and also fitted around the fixing shaft 13, and then secured therein with a cover member 28 by means of a fixing bolt 29 inserting through the cover member 28 and fixedly screwed in the threaded hole 131 of the fixing shaft 13, with the spring 27 pushing resiliently against the fixing member 26 with a proper force. Lastly, the large rotating wheel 30 has its slide grooves 32 aligned to and fitted along the grooved rails 21 of the small rotating wheel 20 to let the clasp 23 of the small rotating wheel 20 tightly engaged in the recessed groove 33 of the large rotating wheel 30.

If a large adhesive tape roll is to be used, just fit its roller around the large rotating wheel 30. On the contrary, in case a small adhesive tape roll is to be employed, a user only has to press the clasp 23 of the small rotating wheel 20 to disengage it from the recessed groove 33 of the large rotating wheel 30 and removes the large rotating wheel 30, and then fits the small adhesive tape roll around the small rotating wheel 20.

As can be noted from the above description, the invention has the following advantages.

1. Since the clasp 23 of the small rotating wheel 20 is provided in front of the cutting device 10, a user can disengage the large rotating wheel 30 from the small rotating wheel 20 simply by pressing down the clasps 23 of the small rotating wheel 20, easy in handling and disassembling.

2. The large rotating wheel 30 is provided with three recessed grooves 33, therefore, when the large rotating wheel 30 is to be assembled on the small rotating wheel 20, a user only has to make the slide grooves 32 of the large rotating wheel 30 aligned to and fitted along the grooved rails 21 of the small rotating wheel 20, convenient in assembling.

3. The outer surface of each groove rail 21 of the small rotating wheel 20 has the convex surface 211 matching with the curvature of a small adhesive tape roll for easily keeping the small adhesive tape roll in position. Besides, the front end of each grooved rail 21 is formed into an outward conical surface 212 to let the slide grooves 32 of the large rotating wheel 30 convenient to be fitted therein, elevating convenience in assembling.

While the preferred embodiment of the invention has been described above, it will be recognized and understood that various modifications may be made therein and the appended claims are intended to cover all such modifications that may fall within the spirit and scope of the invention.

I claim:

1. A tape-roll fitting device of an adhesive tape holder comprising a cutting device, a small rotating wheel and a large rotating wheel:
Said cutting device provided with a handle, a saw-toothed blade for cutting off an adhesive tape, and a fixing shaft positioned lateral therein:
Said small rotating wheel fitted around said fixing shaft, said small rotating wheel having parallel and projecting grooved rails preset in number axially provided around its outer circumference, said small rotating wheel used for a small adhesive tape roll to be axially mounted thereon:
Said large rotating wheel bored with a through shaft hole in the center, said through shaft hole provided on the inner wall with parallel slide grooves preset in number and matching with said grooved rails of said small rotating wheel, said large and said small rotating wheels axially assembled together and rotated synchronously: and,
Characterized by said small rotating wheel formed with a receiving space in the front portion, said receiving space provided with an outward projecting clasp at a predetermined location on the groove wall, said clasp having a cut groove preset in length bored respectively at opposite lengthwise sides, a hook of said clasp extending out of the outer edge of said small rotating wheel and forming a projecting press member; said large rotating wheel provided with three recessed grooves around the outer circumference of the front end, said recessed grooves provided for said clasp of said small rotating wheel to be fixedly secured therein.

2. The tape-roll fitting device of an adhesive tape holder as claimed in claim 1, wherein the outer surface of each said grooved rail is convex-shaped.

3. The tape-roll fitting device of an adhesive tape holder as claimed in claim 1 or 2, wherein the front-end portion of each said grooved rail is formed into a conical surface.
